(19) United States
(12) Patent Application Publication
(10) Pub. No.: US 2010/0096392 A1
(43) Pub. Date: Apr. 22, 2010

(54) CYLINDRICAL FIXING FLANGE STRUCTURE AND HIGH-PRESSURE GAS CONTAINER PROVIDED WITH THE SAME (AS AMENDED)

(76) Inventors: Itsuo Kamiya, Aichi (JP); Kenichi Oota, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/442,964

(22) PCT Filed: Oct. 4, 2007
(86) PCT No.: PCT/JP2007/069891

§ 371 Date: Mar. 26, 2009

(30) Foreign Application Priority Data
Oct. 4, 2006 (JP) 2006-272845

(51) Int. Cl. F17C 13/00

(52) U.S. Cl. 220/581; 220/628

(57) ABSTRACT

There is provided a cylindrical fixing flange structure for a high-pressure gas container filled with high-pressure gas. The cylindrical fixing flange structure includes a high-pressure side primary seal zone provided with a metal touch seal and an atmosphere-side secondary seal zone provided with an elastomer seal. The high-pressure side primary seal zone and the atmosphere-side secondary seal zone are arranged adjacently to each other in the cylinder direction of the high-pressure gas container. The cylindrical fixing flange structure is a sealing structure which has a high degree of freedom of design and is suitable for a high-pressure hydrogen gas container for a fuel cell, in which the durability and reliability against pressurization/depressurization stress, which poses a problem with the sealing structure using elastomer seal only, are ensured, the gastightness is high, and the volume, especially the transverse width, of sealing structure is restrained.

### TECHNICAL FIELD

The present invention relates to a sealing structure for a high-pressure hydrogen gas container suitable for a vehicle, which is used to supply hydrogen to a fuel cell. More particularly, it relates to a cylindrical fixing flange structure for sealing high-pressure hydrogen gas or the like with a small space.

### BACKGROUND ART

In recent years, for motor vehicles, houses, transportation machines, and the like, a gas container (gas cylinder) has been used to store hydrogen gas or natural gas that is used as a fuel for power generation.

For example, a proton-exchange membrane fuel cell has received attention as a power source for a motor vehicle. When electric power is generated by using this fuel cell, an electrochemical reaction is carried out by supplying a gas fuel (for example, hydrogen gas) to one gas diffusion electrode layer of the fuel cell and supplying an oxidant gas (for example, air that contains oxygen) to the other gas diffusion electrode layer thereof. Since only harmless water is yielded at this power generation time, the fuel cell has received attention from the viewpoint of the influence on environment and the utilization efficiency.

To continually supply a gas fuel such as hydrogen gas to a motor vehicle equipped with the fuel cell, the gas fuel is stored in an on-board gas container. Thus, a fuel-cell vehicle must be equipped with a gas container for storing a hydrogen-containing gas (including pure hydrogen) as the fuel gas, and high gastightness is required for a connecting part between the hydrogen gas container and the fuel cell.

In a high-pressure hydrogen gas container (compressed hydrogen gas tank: CHG tank) system for fuel-cell vehicle (FCHV), since a high-pressure hydrogen gas with a pressure of 35 MPa to 75 MPa or higher is charged, a seal using a metallic material and various sealing structures using an elastomer material have been thought of In particular, the development of a sealing material and sealing structure that have high gastightness and can withstand the charge and discharge of high-pressure hydrogen gas performed with great frequency is desired. Since the hydrogen gas taken into elastomer at a high pressure tends to diffuse to the outside of elastomer under reduced pressure, the sealing material and sealing structure must withstand a pressure-varying environment. At the same time, the sealing material and sealing structure must withstand a temperature-varying environment in which the temperature varies in a range of about −70° C. to about 80° C.

However, if rubber or resin having an elastic force is used as a material for a sealing member, there arises a problem in terms of resistance to hydrogen permeability. From the viewpoint of resistance to hydrogen permeability, it is preferable to use a metal as a material for a sealing member. However, since high gastightness is required as described above, the tightening force must inevitably be increased. On the other hand, as the material for the gas container, from the viewpoint of light weight, a relatively soft material such as aluminum tends to be used. Therefore, if the tightening force is increased as described above, there arises a problem in that the gas container is damaged, and therefore the service life of the gas container is reduced.

To solve the above problems, JP Patent Publication (Kokai) No. 2006-9984 discloses a gas sealing structure capable of maintaining a sealing function while protecting a sealed member against damage regardless of the pressure fluctuations of hydrogen-containing gas. This gas sealing structure includes a main sealing member provided around a hydrogen-containing gas flowing portion and an auxiliary sealing member provided on the further outer periphery side of the main sealing member. The main sealing member has a metallic C-shaped part opening to the gas flow side. The C-shaped part has an elastic force and is in contact with the sealed member at at least two points facing to each other to urge the sealed member.

According to the invention disclosed in JP Patent Publication (Kokai) No. 2006-9984, since being made of a metal, the C-shaped part of the main sealing member has high resistance to hydrogen permeability. Also, since the C-shaped part is in contact with the sealed member at at least two points facing to each other, the flow of the hydrogen-containing gas to the outside is shut off. Further, when the pressure of the flowing gas rises, the gas flows into the C-shaped part from the opening position thereof and deforms the C-shaped part so that the C-shaped part is brought into contact with the sealed member. Thereby, even if the gas pressure rises, the sealing function of the main sealing member can be maintained. In the case where the gas pressure rises as described above, since the sealing function is maintained by the deformation of the C-shaped part, the tightening force at the time when the main sealing member is mounted can be reduced. Therefore, the sealed member can be prevented from being damaged, and thus the service life of the sealed member can be prevented from decreasing. In addition, since the C-shaped part can expand and contract with the two contact points being the reference points because the C-shaped part comes into contact with the sealed member at the two contact points, the direction in which the urging force acts does not vary with respect to the fluctuations in pressure of the flowing hydrogen-containing gas, so that the positional shift of the main sealing member can be prevented. Further, since the auxiliary sealing member is provided, the sealing performance can be improved further.

### DISCLOSURE OF THE INVENTION

For the sealing structure disclosed in JP Patent Publication (Kokai) No. 2006-9984, due to the planar fixing sealing structure, the durability against high-pressure stress of elastomer seal is improved by a combination of metal seal on the primary side and elastomer seal on the secondary side. The sealing structure of a planar fixing flange has high assembling properties. However, this sealing structure requires the provision of a flange for forming a seal, so that it has a problem in that a large cross-sectional area is needed longitudinally and transversely as a sealing structure. Thus, the sealing structure using both of metal seal and elastomer seal has a necessarily increased cross-sectional area of seal flange.

This point raises an important problem in terms of the degree of freedom of design, too, especially when a large number of cylindrical high-pressure hydrogen gas containers are mounted in a limited space as on a fuel-cell vehicle.

Accordingly, an object of the present invention is to provide a sealing structure which has a high degree of freedom of design and is suitable for a fuel cell, in which the durability and reliability against pressurization/depressurization stress, which poses a problem with the sealing structure using elastomer seal only, are ensured, the gastightness is high, and the volume, especially the transverse width, of sealing structure is restrained.

The inventor found that the above-described problems can be solved by a specific arrangement structure of metal touch seal and elastomer seal, and arrived at the present invention.

Firstly, the present invention provides a cylindrical fixing flange structure for a high-pressure gas container filled with high-pressure gas. The cylindrical fixing flange structure includes a high-pressure side primary seal zone provided with a metal touch seal and an atmosphere-side secondary seal zone provided with an elastomer seal, and the high-pressure side primary seal zone and the atmosphere-side secondary seal zone are arranged adjacently to each other in the cylinder direction of the high-pressure gas container.

According to the present invention, by the cylindrical fixing flange structure in which the metal touch seal on the primary side and the elastomer seal on the secondary side are combined together, the gastightness and the durability against high-pressure stress of elastomer seal can be improved, and the sealing structure can be made transversely compact.

The cylindrical fixing flange structure in accordance with the present invention is effective as a sealing structure for various high-pressure gas containers, and in particular, is made suitable for a high-pressure hydrogen gas container for a fuel-cell vehicle by making the best use of the above-mentioned advantages.

As the metal touch seal of the high-pressure side primary seal zone, a structure of one type or a combination of two or more types selected from the structures in the items (1) to (4) below is preferably employed.
(1) Flange end face seal
(1′) Taper flange end face seal
(2) Tightening screw for fixing cylindrical flange (2′) Tightening screw for fixing cylindrical flange sealed by anaerobic thread sealing compound (combined by applying an anaerobic sealing compound having a high reactivity with metal to a metal part screw seal)
(3) Metal gasket seal
(4) Metal C-shaped seal or metal O-ring
(5) Ceramic gasket seal

As the atmosphere-side secondary seal zone, a structure having both of an elastomer seal and an elastomer extrusion preventing ring is preferably used.

Secondly, the present invention provides a high-pressure gas container, especially a high-pressure hydrogen gas container, provided with the above-described cylindrical fixing flange structure. More specifically, it provides a high-pressure hydrogen gas container for a vehicle, which supplies hydrogen to a fuel cell of a fuel-cell vehicle.

Thirdly, the present invention provides a fuel-cell vehicle that is mounted with the high-pressure hydrogen gas container provided with the above-described cylindrical fixing flange structure.

According to the cylindrical fixing flange structure in accordance with the present invention, which is a sealing part of the high-pressure gas (especially hydrogen gas) container, (1) by the cylindrical fixing flange structure in which the metal touch seal on the primary side and the elastomer seal on the secondary side are combined together, the gastightness and the durability against high-pressure stress of elastomer seal can be improved, and (2) the sealing structure can be made transversely compact as compared with a planar fixing flange structure. The high-pressure gas (especially hydrogen gas) container in accordance with the present invention, which is provided with the above-mentioned sealing structure, has excellent durability, and is best suitable especially as a high-pressure hydrogen gas container for a fuel-cell vehicle.

### BRIEF DESCRIPTION OF THE DRAWINGS

FIG. 1 is a sectional view showing a cylindrical fixing flange structure of an example of the present invention.

FIG. 2 is a sectional view showing a cylindrical fixing flange structure of another example of the present invention.

FIG. 3 is a sectional view showing a cylindrical fixing flange structure of still another example of the present invention.

FIG. 4 is a sectional view showing a cylindrical fixing flange structure of still another example of the present invention.

FIG. 5 is a sectional view showing a cylindrical fixing flange structure of still another example of the present invention.

FIG. 6 is a sectional view showing a cylindrical fixing flange structure of still another example of the present invention.

FIG. 7 is a sectional view showing a cylindrical fixing flange structure of still another example of the present invention.

FIG. 8 is a sectional view showing a cylindrical fixing flange structure of still another example of the present invention.

FIG. 9 is a sectional view showing a cylindrical fixing flange structure of still another example of the present invention.

FIG. 10 is a sectional view showing a planar fixing flange structure of a comparative example.

Hereunder, reference numerals are explained: 10: high pressure primary-side seal zone, 11: taper flange end face seal, 12: tightening screw for fixing cylindrical flange, 13: anaerobic thread sealing compound, 14: metal touch seal, 15: metal gasket seal, 16: metal C-shaped seal, 20: atmosphere-side secondary seal zone, 21: elastomer seal, 22: elastomer extrusion preventing ring.

### BEST MODE FOR CARRYING OUT THE INVENTION

Examples and comparative example of the present invention will now be explained with reference to the accompanying drawings.

### Example 1

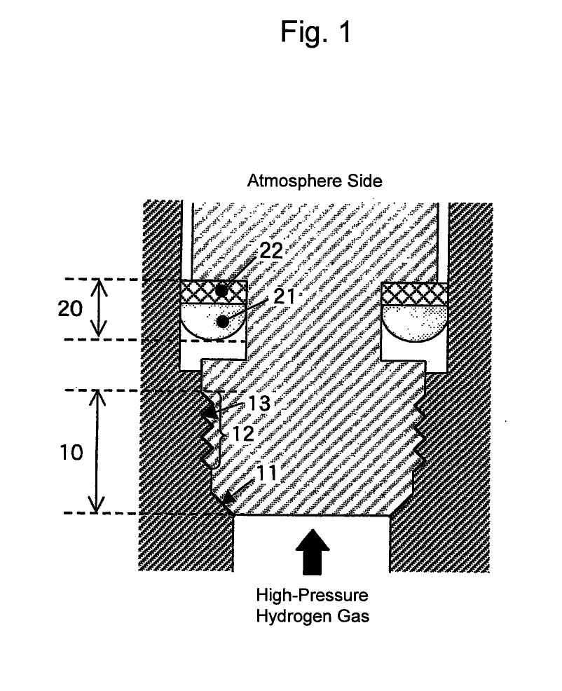

FIG. 1 is a sectional view showing a cylindrical fixing flange structure of an example of the present invention. In a high pressure primary-side seal zone 10, a taper flange end face seal 11 and a tightening screw 12 for fixing cylindrical flange are combined together, and further the threaded part of the tightening screw 12 for fixing cylindrical flange is completely sealed by an anaerobic thread sealing compound 13. An atmosphere-side secondary seal zone 20 is arranged adjacently to the high pressure primary-side seal zone 10 in the cylinder direction. The atmosphere-side secondary seal zone 20 has a construction having both of an elastomer seal 21 and an elastomer extrusion preventing ring 22.

The high pressure primary-side seal zone 10 reduces pressurization/depressurization stress applied to the elastomer seal 21 arranged in the atmosphere-side secondary seal zone 20. The above-described cylindrical fixing flange structure is useful for saving space of sealing structure.

### Example 2

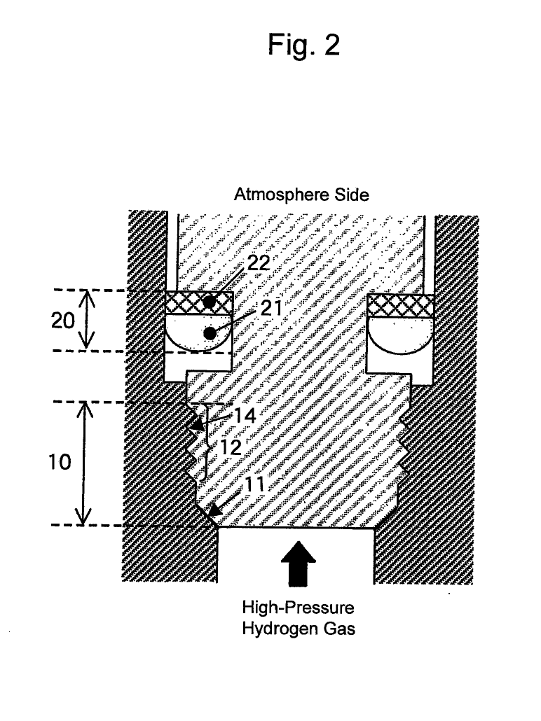

FIG. 2 is a sectional view showing a cylindrical fixing flange structure of another example of the present invention. In a high pressure primary-side seal zone 10, a taper flange end face seal 11 and a tightening screw 12 for fixing cylindrical flange are combined together, and in particular, the threaded part of the tightening screw 12 for fixing cylindrical flange provides a metal touch seal 14. An atmosphere-side secondary seal zone 20 is arranged adjacently to the high pressure primary-side seal zone 10 in the cylinder direction. The atmosphere-side secondary seal zone 20 has a construction having both of an elastomer seal 21 and an elastomer extrusion preventing ring 22.

As in Example 1, the high pressure primary-side seal zone 10 reduces pressurization/depressurization stress applied to the elastomer seal 21 arranged in the atmosphere-side secondary seal zone 20. The above-described cylindrical fixing flange structure is useful for saving space of sealing structure.

### Example 3

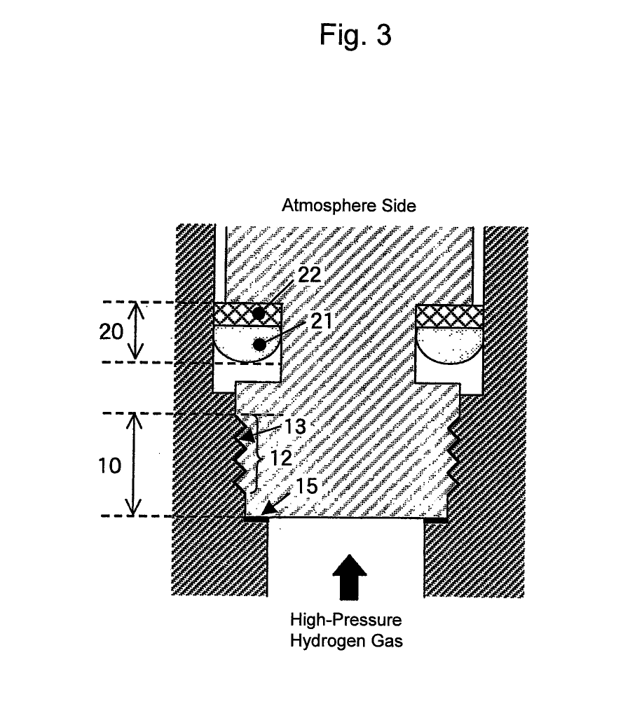

FIG. 3 is a sectional view showing a cylindrical fixing flange structure of still another example of the present invention. In a high pressure primary-side seal zone 10, a metal gasket seal 15 and a tightening screw 12 for fixing cylindrical flange are combined together, and further the threaded part of the tightening screw 12 for fixing cylindrical flange is completely sealed by an anaerobic thread sealing compound 13. An atmosphere-side secondary seal zone 20 is arranged adjacently to the high pressure primary-side seal zone 10 in the cylinder direction. The atmosphere-side secondary seal zone 20 has a construction having both of an elastomer seal 21 and an elastomer extrusion preventing ring 22.

As in Example 1, the high pressure primary-side seal zone 10 reduces pressurization/depressurization stress applied to the elastomer seal 21 arranged in the atmosphere-side secondary seal zone 20. The above-described cylindrical fixing flange structure is useful for saving space of sealing structure.

### Example 4

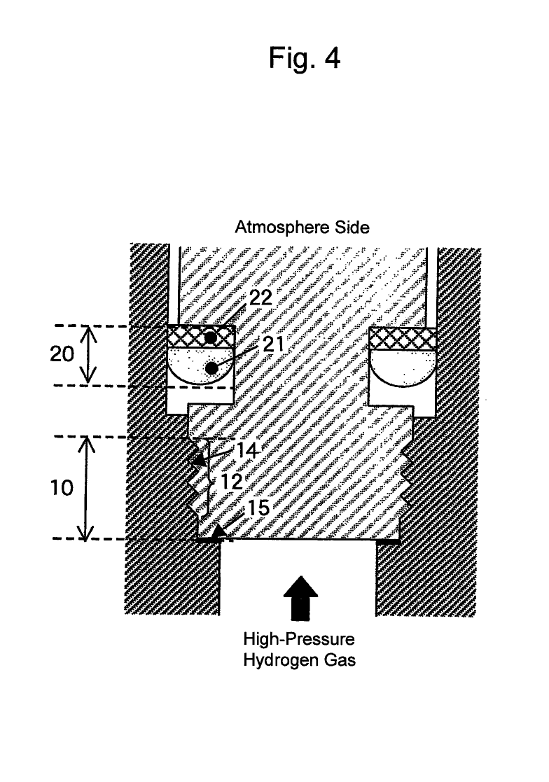

FIG. 4 is a sectional view showing a cylindrical fixing flange structure of still another example of the present invention. In a high pressure primary-side seal zone 10, a metal gasket seal 15 and a tightening screw 12 for fixing cylindrical flange are combined together, and in particular, the threaded part of the tightening screw 12 for fixing cylindrical flange provides a metal touch seal 14. An atmosphere-side secondary seal zone 20 is arranged adjacently to the high pressure primary-side seal zone 10 in the cylinder direction. The atmosphere-side secondary seal zone 20 has a construction having both of an elastomer seal 21 and an elastomer extrusion preventing ring 22.

As in Example 1, the high pressure primary-side seal zone 10 reduces pressurization/depressurization stress applied to the elastomer seal 21 arranged in the atmosphere-side secondary seal zone 20. The above-described cylindrical fixing flange structure is useful for saving space of sealing structure.

### Example 5

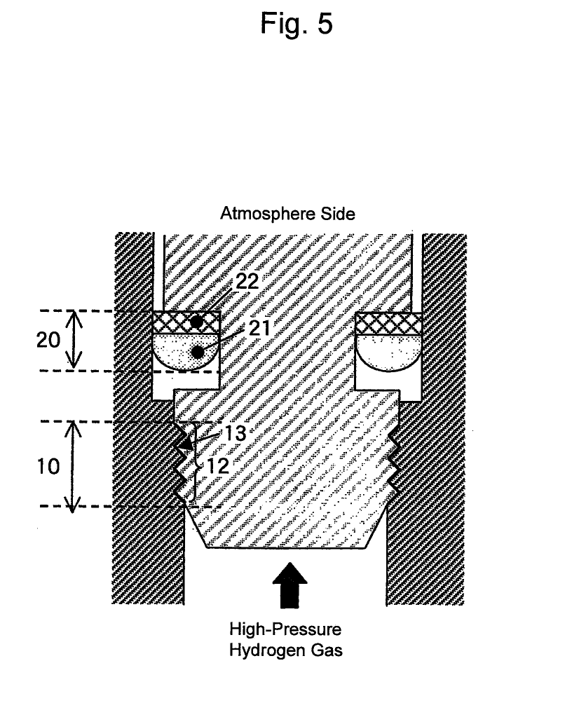

FIG. 5 is a sectional view showing a cylindrical fixing flange structure of still another example of the present invention. In a high pressure primary-side seal zone 10, the threaded part of a tightening screw 12 for fixing cylindrical flange is completely sealed by an anaerobic thread sealing compound 13. An atmosphere-side secondary seal zone 20 is arranged adjacently to the high pressure primary-side seal zone 10 in the cylinder direction. The atmosphere-side secondary seal zone 20 has a construction having both of an elastomer seal 21 and an elastomer extrusion preventing ring 22.

As in Example 1, the high pressure primary-side seal zone 10 reduces pressurization/depressurization stress applied to the elastomer seal 21 arranged in the atmosphere-side secondary seal zone 20. The above-described cylindrical fixing flange structure is useful for saving space of sealing structure.

### Example 6

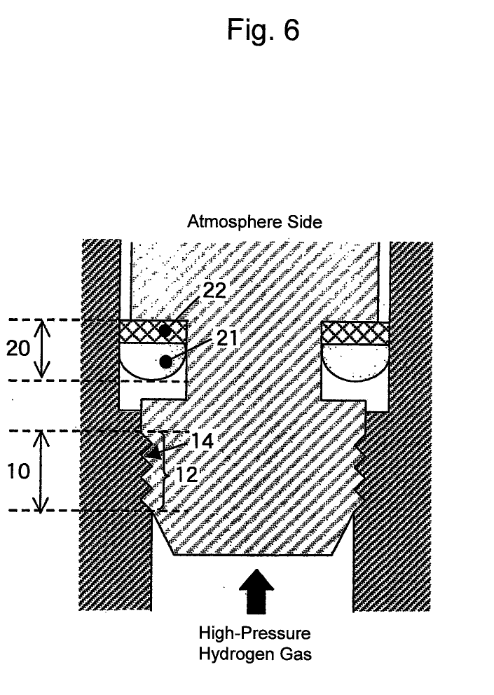

FIG. 6 is a sectional view showing a cylindrical fixing flange structure of still another example of the present invention. A high pressure primary-side seal zone 10 consists of a tightening screw 12 for fixing cylindrical flange, and the threaded part of the tightening screw 12 for fixing cylindrical flange provides a metal touch seal 14. An atmosphere-side secondary seal zone 20 is arranged adjacently to the high pressure primary-side seal zone 10 in the cylinder direction. The atmosphere-side secondary seal zone 20 has a construction having both of an elastomer seal 21 and an elastomer extrusion preventing ring 22.

As in Example 1, the high pressure primary-side seal zone 10 reduces pressurization/depressurization stress applied to the elastomer seal 21 arranged in the atmosphere-side secondary seal zone 20. The above-described cylindrical fixing flange structure is useful for saving space of sealing structure.

### Example 7

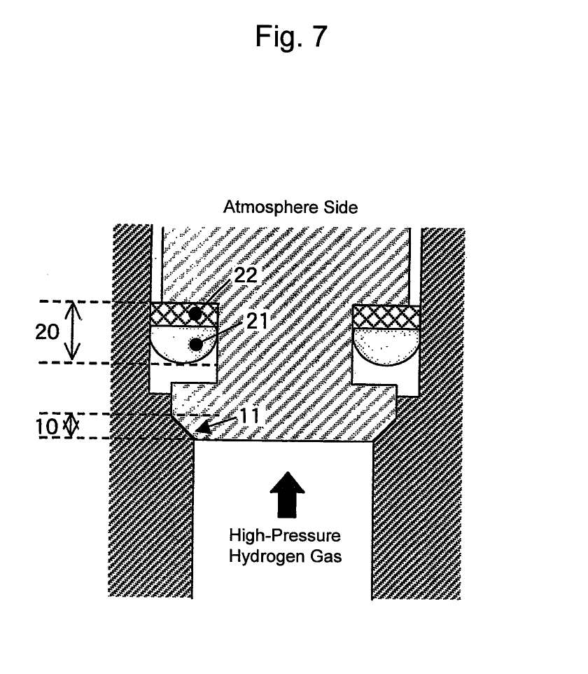

FIG. 7 is a sectional view showing a cylindrical fixing flange structure of still another example of the present invention. A high pressure primary-side seal zone 10 consists of a taper flange end face seal 11. An atmosphere-side secondary seal zone 20 is arranged adjacently to the high pressure primary-side seal zone 10 in the cylinder direction. The atmosphere-side secondary seal zone 20 has a construction having both of an elastomer seal 21 and an elastomer extrusion preventing ring 22.

As in Example 1, the high pressure primary-side seal zone 10 reduces pressurization/depressurization stress applied to the elastomer seal 21 arranged in the atmosphere-side secondary seal zone 20. The above-described cylindrical fixing flange structure is useful for saving space of sealing structure.

### Example 8

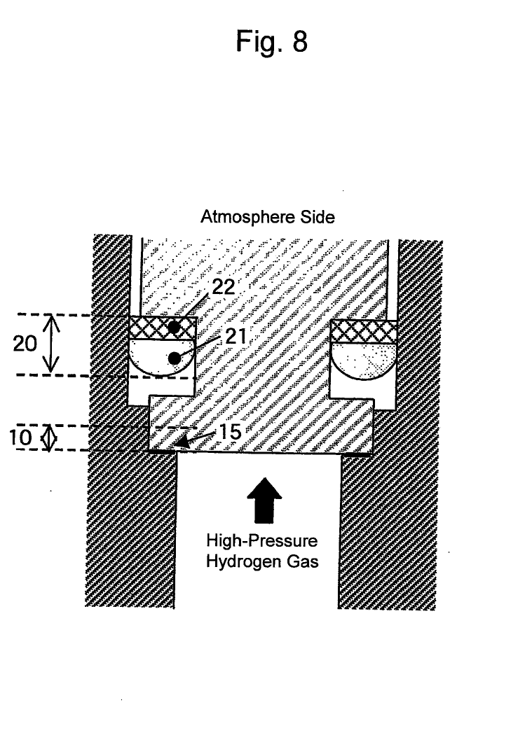

FIG. 8 is a sectional view showing a cylindrical fixing flange structure of still another example of the present invention. A high pressure primary-side seal zone 10 consists of a metal gasket seal 15. An atmosphere-side secondary seal zone 20 is arranged adjacently to the high pressure primary-side seal zone 10 in the cylinder direction. The atmosphere-side secondary seal zone 20 has a construction having both of an elastomer seal 21 and an elastomer extrusion preventing ring 22.

As in Example 1, the high pressure primary-side seal zone 10 reduces pressurization/depressurization stress applied to the elastomer seal 21 arranged in the atmosphere-side secondary seal zone 20. The above-described cylindrical fixing flange structure is useful for saving space of sealing structure.

### Example 9

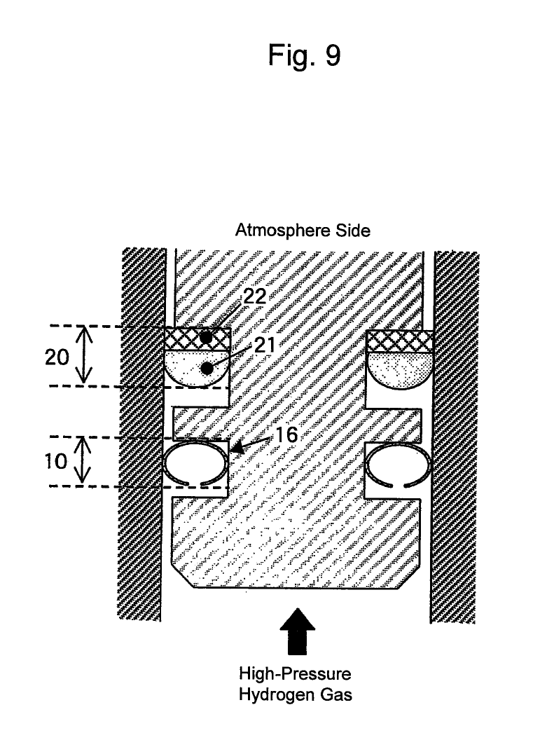

FIG. 9 is a sectional view showing a cylindrical fixing flange structure of still another example of the present invention. A high pressure primary-side seal zone 10 consists of a metal C-shaped seal 16. Although the metal C-shaped seal 16 is used in FIG. 9, a metal O-ring may be used. An atmosphere-side secondary seal zone 20 is arranged adjacently to the high pressure primary-side seal zone 10 in the cylinder direction. The atmosphere-side secondary seal zone 20 has a construction having both of an elastomer seal 21 and an elastomer extrusion preventing ring 22.

As in Example 1, the high pressure primary-side seal zone 10 reduces pressurization/depressurization stress applied to the elastomer seal 21 arranged in the atmosphere-side secondary seal zone 20. The above-described cylindrical fixing flange structure is useful for saving space of sealing structure.

### Comparative Example

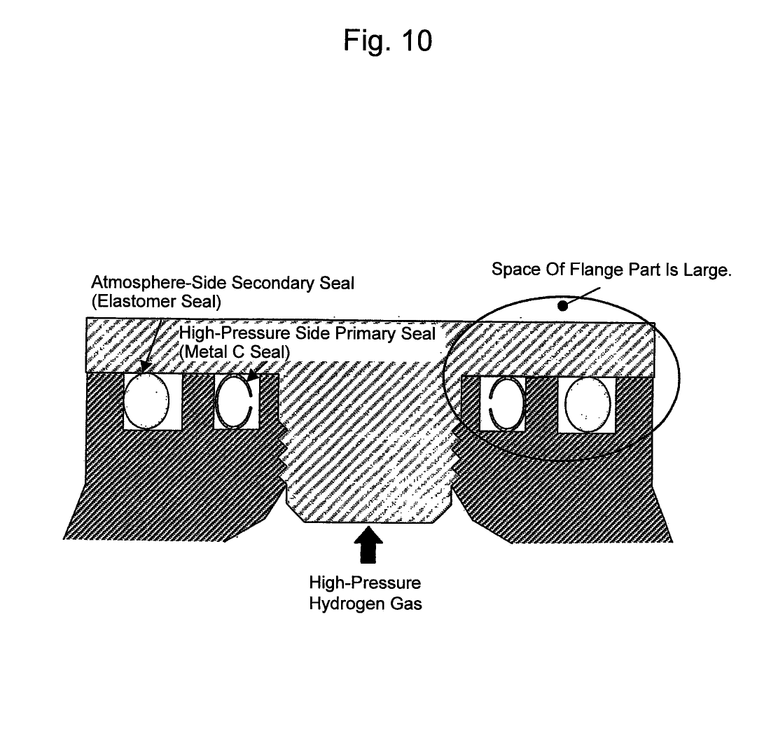

FIG. 10 is a sectional view showing a planar fixing flange structure of a comparative example of the present invention. In this planar fixing flange structure, it is preferable that a metal C-shaped seal be arranged for a high pressure primary-side seal, and an elastomer seal be arranged for an atmosphere-side secondary seal. The high pressure primary-side seal and the atmosphere-side secondary seal are disposed on a plane. As is apparent from FIG. 10, the space for the flange part is large. Therefore, it becomes clear that the planar fixing flange structure is unsuitable for mounting a large number of cylindrical high-pressure hydrogen gas containers in a limited space as on a fuel-cell vehicle.

### INDUSTRIAL APPLICABILITY

For the cylindrical fixing flange structure in accordance with the present invention, the gastightness and the durability against high-pressure stress of elastomer seal can be improved, and the sealing structure can be made transversely compact. The high-pressure gas (especially hydrogen gas) container in accordance with the present invention, which is provided with the above-described sealing structure, has excellent durability and is best suitable especially as a high-pressure hydrogen container for a fuel-cell vehicle. Therefore, the high-pressure hydrogen gas container in accordance with the present invention contributes to the practical use and spread of fuel-cell vehicles.

1. A cylindrical fixing flange structure for a high-pressure gas container filled with high-pressure gas, comprising a high-pressure side primary seal zone provided with a flange end face seal serving as a metal tough seal and an atmosphere-side secondary seal zone provided with an elastomer seal, the high-pressure side primary seal zone and the atmosphere-side secondary seal zone being arranged adjacently to each other in the cylinder direction of the high-pressure gas container.

2. The cylindrical fixing flange structure according to claim 1, wherein the high-pressure gas is hydrogen gas.

3. (canceled)

4. The cylindrical fixing flange structure according to claim 1, wherein the flange end face has a taper shape.

5. (canceled)

6. The cylindrical fixing flange structure according to claim 1, wherein the metal touch seal has both of a flange end face seal and a tightening screw for fixing cylindrical flange.

7. The cylindrical fixing flange structure according to claim 6, wherein the tightening screw for fixing cylindrical flange is sealed by an anaerobic thread sealing compound.

8. (canceled)

9. The cylindrical fixing flange structure according to claim 1, wherein the metal touch seal has both of a metal gasket seal and a flange end face seal or has both of a metal gasket seal and a flange end face seal and a tightening screw for fixing cylindrical flange.

10. (canceled)

11. The cylindrical fixing flange structure according to claim 1, wherein the metal touch seal has both of a metal C-shaped seal or a metal O-ring and a flange end face seal, or has both of the metal C-shaped seal or the metal O-ring and a metal gasket seal and the flange end face seal, or has both of the metal C-shaped seal or the metal O-ring and the metal gasket seal and the flange end face seal and a tightening screw for fixing cylindrical flange.

12. The cylindrical fixing flange structure according to claim 1, wherein the atmosphere-side secondary seal zone has both of an elastomer seal and an elastomer extrusion preventing ring.

13. A high-pressure gas container provided with the cylindrical fixing flange structure described in claim 1.

14. A fuel-cell vehicle which is mounted with a high-pressure gas container provided with the cylindrical fixing flange structure described in claim 1.
